(19) United States
(12) Patent Application Publication
(10) Pub. No.: US 2003/0236769 A1
(43) Pub. Date: Dec. 25, 2003

(54) Method and device for mobile communication

(75) Inventor: Seppo Pyhalammi, Helsinki (FI)

Correspondence Address: BANNER & WITCOFF, 1001 G STREET N W, SUITE 1100, WASHINGTON, DC, 20001, US

(73) Assignee: Nokia Corporation, ESPOO (FI)

(21) Appl. No.: 10/452,880

(22) Filed: Jun. 3, 2003

(30) Foreign Application Priority Data
Jun. 20, 2002 (FI) 20021213

(51) Int. Cl. G06F 7/00

(52) U.S. Cl. 707/1

(57) ABSTRACT

A method and a system for storing contact information in the memory of a first electronic device (310), which is capable of communicating via a communication network, with at least one second electronic device (320, 340). The method comprises establishing a communication connection on the basis of a first piece of contact information between said first electronic device and at least one second electronic device (320, 340). The method also comprises receiving at least one second piece of contact information as a response to the first piece of contact information formed, the second piece of contact information being related to said first piece of contact information, storing said second piece of contact information in the memory of said first electronic device (310), and linking said first piece of contact information and said at least one second piece of contact information to point to one another.

The present invention relates to a method and a device for mobile communication and in particular, but not necessarily, a method for updating a register of contact information in a mobile station.

### BACKGROUND OF THE TECHNIQUE

Inputting new contact data, such as telephone numbers and names to the memory of an electronic device, such as a mobile station, is a task that many people find difficult or laborious. This is common especially among users who seldom use this procedure. In the future this will be even more laborious, because in addition to the name and telephone number, other contact information, such as the e-mail or Internet page address, must be input to the memory of the device.

In order to store the contact information in the user's mobile station as easily as possible, all contact information available should be automatically stored in the mobile station on the basis of a certain piece of contact information, preferably when the user of the mobile station establishes a connection on the basis of said certain piece of contact information.

A method and a system for providing information related to a computer network have been presented in U.S. Pat. No. 6,067,546. For example, subscriber B (called party) receives the telephone number of subscriber A (calling party). The device of subscriber B (customer premises equipment, GPE) or the elements of the telephone network use said telephone number for indexing the database, which contains combinations of telephone numbers and computer network addresses. When the computer network address of subscriber A has been retrieved to the device of subscriber B, the information created by subscriber A, such as a web page (the location of which in the network is specified by said computer network address) can be transmitted to subscriber B and presented in the device of subscriber B. In addition, the telephone number of subscriber A can be sent by subscriber B to an application located in the computer network, the application causing automatic presentation of the information created by subscriber A in the device of subscriber B.

The application number EP 869688 discloses a method and a device for transferring service pages implemented in a telecommunication network, such as the Internet, to a terminal device. Transferring a service page according to the invention presented in the application enables the presentation of versatile information on the display of a terminal device connected to a telecommunication network on the basis of CLIP (Calling Line Identification Presentation) or CoLP (Connected Line Identification Presentation) identification information. This is implemented by transferring, for example, to the display of subscriber A the service page selected by subscriber B, which can be used for advertising, for example. When subscriber A has established a telephone connection to subscriber B, the CoLP information is transmitted to subscriber A. After this, subscriber A contacts the Internet address server, whereupon the CoLP information is also transmitted to said address server. If the Internet address corresponding to the CoLP information is found in the database of said server, said Internet address is transmitted to subscriber A. After this, subscriber A contacts the Internet address received, downloads the service page and shows the service page retrieved on the display of the terminal device. This embodiment is suitable for situations in which, for example, the client calls the number of a company offering certain products or services, and gets automatically further information about the products or services provided by the company to his terminal device in the form of a service page. However, the use of the CoLP service instead of the CLIP service provides an advantage. Subscriber A, to whom the advertisement is directed, can be sure of the origin of the advertisement, because call transfers possibly implemented in the telephone network, for example, cannot affect the validity of the CoLP service.

Both of the prior art solutions described above require downloading a web page, which is relatively slow with the present mobile stations.

### SUMMARY OF THE INVENTION

A method and a device have now been invented by which the contact information is stored in the user's mobile station as a response to an established communication connection. The first mobile station user, such as subscriber A, establishes a connection with the first mobile station to a second mobile station, for example, such as subscriber B, on the basis of a first piece of contact information related to the second mobile station user, such as a telephone number. When a connection has been established, subscriber A receives other contact information related to subscriber B, such as address information, in his mobile station on request.

Storing the contact information in the user's mobile station is easy and requires no extra effort. All other contact information available that relates to a certain first piece of contact information is preferably stored automatically when the user of the mobile station establishes a connection on the basis of said certain first piece of contact information.

According to a first aspect of the invention, a method has been implemented for storing contact information in the memory of a first electronic device, the first electronic device being capable of communicating via a communication network with at least a second electronic device; the method comprises the steps of: inputting a first piece of contact information to the first electronic device for establishing a communication connection to said at least one second electronic device, establishing a communication connection via said communication network between said first electronic device and said at least one second electronic device on the basis of said first piece of contact information, characterized in that the method also comprises: sending a request message by said first electronic device to said at least one second electronic device on the basis of said communication connection, the request message comprising a request for sending at least one second contact information update relating to said first piece of contact information to said first electronic device, sending a feedback message as a response to said request message by said at least one second electronic device, the feedback message comprising at least one second piece of contact information related to said first piece of contact information, and storing said first piece of contact information and said at least one second piece of contact information in the memory of said first electronic device.

According to a second aspect of the invention, a first electronic device has been implemented for storing contact information in the memory of said device, the device being capable of communicating via a communication network with at least a second electronic device; the device comprises: input means for inputting a first piece of contact information to the first electronic device for establishing a communication connection to said at least one second electronic device, communication means for establishing a communication connection via said communication network between said first device and said at least one second electronic device on the basis of said first piece of contact information, characterized in that said device also comprises: request message generating means, the request message comprising a request for sending at least one second piece of contact information related to said first piece of contact information to said device, request message transmission means for sending a request message by said device to at least one second electronic device on the basis of the communication connection established, reception means for receiving a feedback message, which comprises at least one second piece of contact information, as a response to the transmitted request message, the second piece of contact information relating to said first piece of contact information, storage means for storing said first piece of contact information and said second piece of contact information in the memory of said device.

According to a third aspect of the invention, there is implemented a system for storing contact information in the memory of a first electronic device; the system comprises a first electronic device and at least one second electronic device, the first electronic device being capable of communicating via a communication network with at least a second electronic device, the system comprises input means for inputting a first piece of contact information to the first electronic device for establishing a communication connection to said at least one second electronic device, communication means for establishing a communication connection via said communication network between said first electronic device and said at least one second electronic device on the basis of said first piece of contact information, characterized in that the system comprises: request message transmission means for sending a request message by said first electronic device to at least one second electronic device on the basis of the communication connection established, the request message comprising a request for sending at least one second piece of contact information related to said first piece of contact information to said first electronic device, feedback message transmission means for sending a feedback message on the basis of a request message received from said at least one second electronic device, the feedback message comprising at least one second piece of contact information related to said first piece of contact information, and storage means for storing said first piece of contact information and said second piece of contact information in the memory of said first electronic device.

According to a fourth aspect of the invention, a computer software product has been implemented for an electronic device for storing contact information in said electronic device, the electronic device being capable of establishing a communication connection via a communication network with at least one second electronic device on the basis of a first piece of contact information formed in said first electronic device, characterized in that the computer software product comprises: computer software means for generating a request message, the request message comprising a request for sending at least one second piece of contact information related to said first piece of contact information to said device, computer software means for making said first electronic device send said request message to at least one second electronic device on the basis of the communication connection established, computer software means for making said electronic device receive a feedback message, which comprises at least one second piece of contact information, as a response to the request message transmitted, the second piece of contact information relating to said first piece of contact information, computer software means for storing said first piece of contact information and said at least one second piece of contact information in the memory of said electronic device.

In the following, the invention will be described in more detail with reference to the accompanying drawings, in which

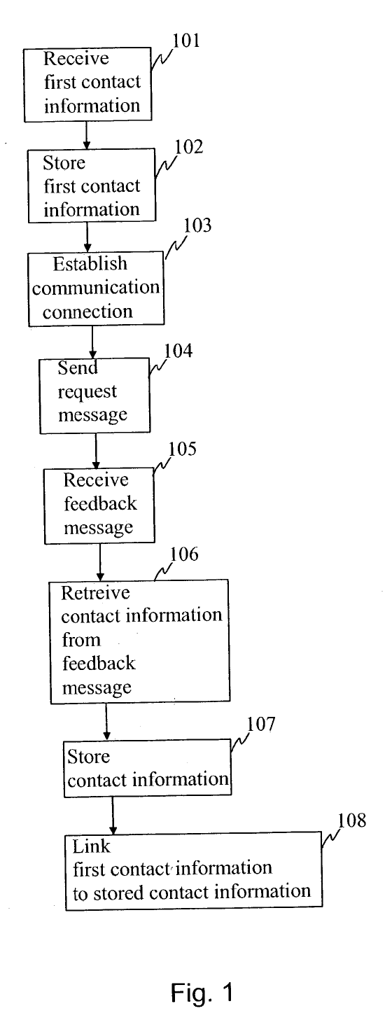

FIG. 1 is a flow diagram of a method according to an embodiment of the invention;

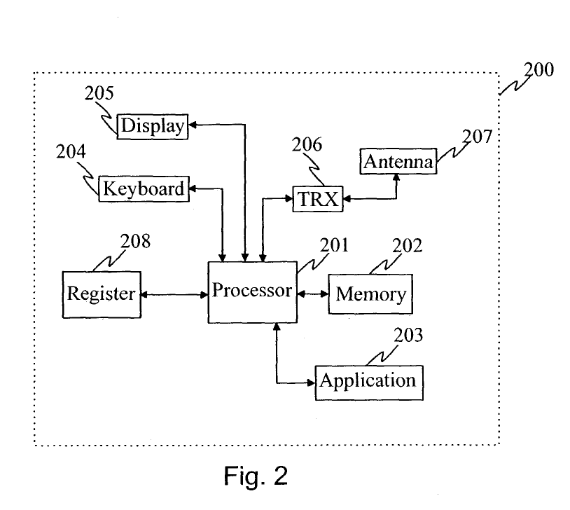

FIG. 2 shows an electronic device according to an embodiment of the invention;

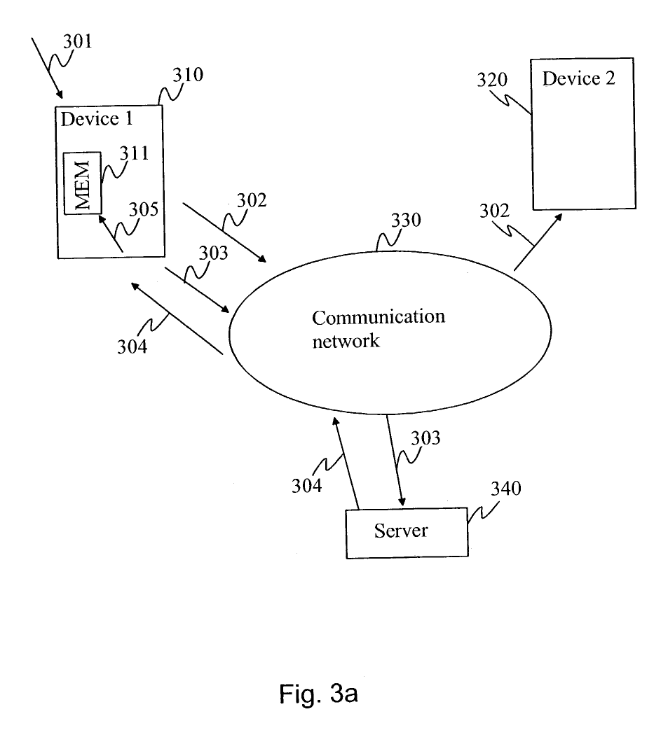

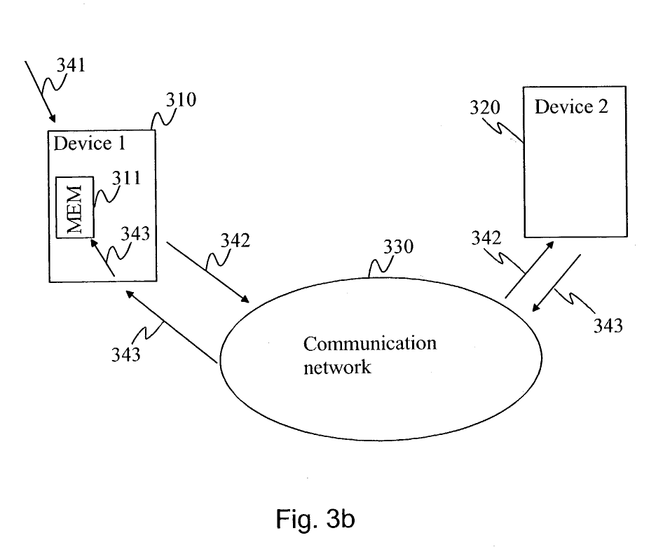

FIG. 3a shows a system according to an embodiment of the invention;

FIG. 3b shows a system according to an alternative embodiment of the invention;

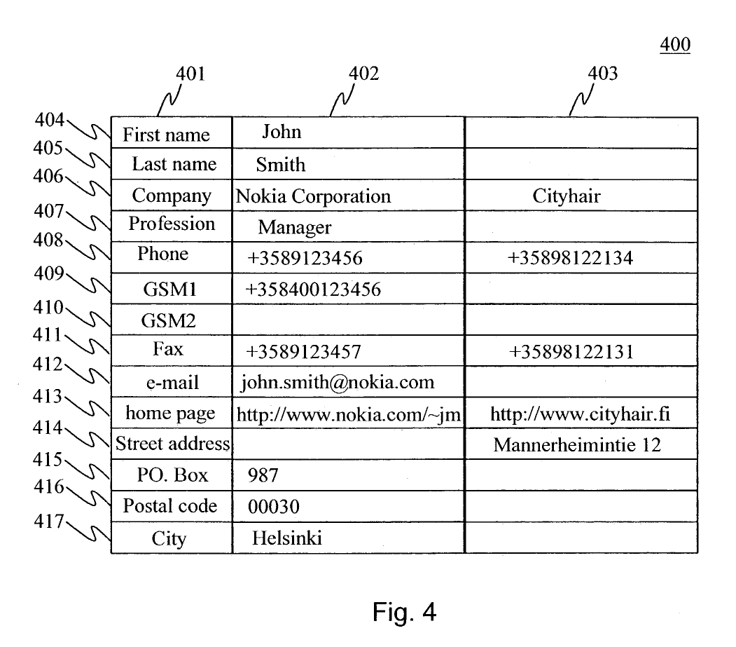

FIG. 4 shows a list of contact information according to an embodiment of the invention;

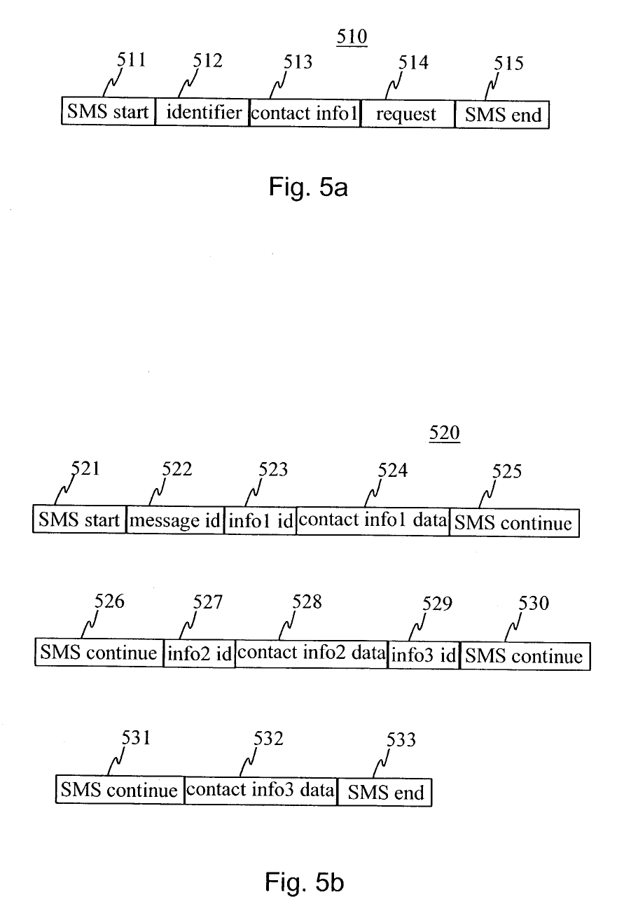

FIG. 5a shows the structure of a request message according to an embodiment of the invention; and

FIG. 5b shows the structure of a feedback message according to an embodiment of the invention.

FIG. 1 is a flow diagram of a method according to an embodiment of the invention. The steps of the method can be advantageously implemented with a computer program code stored in the electronic device. In order to illustrate the presentation, reference is made in the following to the mobile stations 310, 320, communication network 330 and server 340 shown in FIGS. 3a and 3b. In step 101, the user of an electronic device, such as a mobile station 310, inputs to the mobile station 310 the first piece on contact information, such as the telephone number of the user of a second mobile station 320, on the basis of which a communication connection is established between the mobile stations 310 and 320. Alternatively, the communication connection between the mobile stations 310 and 320 can be established on the basis of an e-mail address or a web address. The mobile station 310 stores the received piece of contact information in the memory for possible later use in step 102. If a communication connection is established with another mobile station 320, for example, in step 103, the mobile station 310 sends in step 104, after the communication connection has been established, a request message to the mobile station 320, asking for further contact information related to said first piece of contact information. This takes place so that the mobile station 310 sends a request message preferably as an SMS message to the mobile station 320, the request message comprising a request to send at least one second piece of contact information related to said first piece of contact information. The SMS message can be, for example, an SMS message standardized in the GSM system (SMS, Short Message Service). The feedback message and request message are not limited for implementation merely as SMS messages, but other types of messages, such as MMS messages (MMS, Multi Media Service), can be used for implementing the invention.

The transmission of the request message is dependent on the settings of the mobile station. The user of the terminal can determine whether the request message is sent automatically when the communication connection is established, or separately when the user so wishes. If an automatic request message has been selected in the settings, the request message is preferably transmitted during the communication connection. Alternatively, or if the request message cannot be sent during the communication connection, the request message can also be sent before establishing the communication connection or after it. The user accepts the transmission of the request message e.g. by pressing a key as a reply to a prompt shown on the display of the device by the computer software application, giving the user a possibility to accept or to reject the transmission of a request message by pressing a key. If the second mobile station 320 can offer at least one second piece of contact information, it is sent by the mobile station 320 or by the user of said mobile station as a feedback message e.g. in one ordinary or concatenated SMS message. Sending the feedback message takes place in such a manner, for example, that a computer software application installed in the mobile station 320 is activated by the user of the mobile station 320, after which the computer software application automatically generates a predetermined feedback message when the mobile station 320 receives a request message, and the feedback message is transmitted to the mobile station 310. The computer software application recognizes the received message as a request message on the basis of an identifier in the message. In addition, the sender of the message is recognized on the basis of a subscriber identifier, for example. After the recognition, the computer software application returns a feedback message either automatically or at the user's request. The feedback message comprises at least one second piece of contact information, which can be e.g. the telephone, fax or pager number of a person or a company, a name or an address, but it can also comprise other information. If the feedback message is a multimedia message, it can comprise e.g. an image, which can be in the jpeg format, for example. The user of the mobile station 320 can, when he so wishes, specify the piece(s) of contact information that the user wants to offer to the users of other mobile stations, in this case to the user of mobile station 310. Said feedback message is received by mobile station 310 (step 105), whereupon the contact information is retrieved from the feedback message as explained below in connection with the description of FIGS. 5a and 5b. The contact information is stored in the memory or register of mobile station 310 (step 107), and finally said first piece of contact information and the other contact information received are linked to refer to each other in said memory or register (step 108). The feedback message can be sent either during the communication connection or after it, if it is not possible to send it during the communication connection.

Alternatively, the request message can be sent in step 104 to a server 340, for example, such as a contact information server, in which address information of the users of the mobile station have been stored. The request message is received by the server, and if at least one second piece of contact information related to said first piece of contact information has been stored on the server 340, a feedback message is sent from the server via the communication network 330 to the mobile station 310, which receives said feedback message (step 105). In the mobile station 310, the contact information is retrieved from the feedback message (step 106) and stored in the memory of the mobile station 310 (step 107), and finally said received contact information and said first piece of contact information are linked to each other in step 108. If no second piece of contact information is found, the server 340 or the mobile station 320 can inform the mobile station 310 in an SMS message, for example, that information is not available.

FIG. 2 shows an electronic device 200 according to an embodiment of the invention. The device 200 is preferably a mobile station that operates in a wireless radio frequency cellular communication system, such as the GSM system. The device 200 comprises a processor 201 for performing operations in a device 200, a memory 202 for storing information, at least one application 203 for generating and sending a request message, for example, a keyboard 204 for inputting information, a display 205 for presenting information, a transceiver 206 and an antenna 207 for transmitting information wirelessly to a communication network. The device 200 also comprises a register 208, in which contact information, such as name, telephone number, e-mail, Internet address or mail address information of private persons or companies have been stored. Both the application 203 and the register 208 can be stored in the memory 202, although they have been presented as separate blocks here. The device 200 has been arranged to send the request message and the feedback message as a text message or a multimedia message, for example, by the application 203, the processor 201 and the transceiver 206 to at least one second electronic device. The request message is transmitted as a response to the established communication connection that has been perceived by the application. The request message comprises a request for sending at least one second piece of contact information related to said first piece of contact information to the device 200. The feedback message is sent by the device 200 on the basis of the request message received by the device, the feedback message comprising at least one second piece of contact information relating to the device 200 or the user of the device 200. The transceiver 206 sends, under the control of the processor 206, the above mentioned request and feedback message as a short message, such as an SMS message, or a multimedia message, such as an MMS message. As is known, in the GSM system the maximum length of a text message is 160 characters. If the request or feedback message is longer than said 160 characters, it is sent in several messages in a manner known by a person skilled in the art, for example as a so-called concatenated message.

The device also comprises reception means (201-207) for receiving a feedback and request message to the device 200. The feedback and request message comprise an identifier on the basis of which the reception means can handle the message received in an appropriate manner. Then the request message arriving at the mobile station is recognized as a message asking for contact information, and a feedback message is sent as a response to the recognized request message. The transmission of the feedback message depends on the settings of the device 200. The device 200 can be set by the user in a state in which the device automatically sends a feedback message after receiving a request message, which is recognized by the device 200 as a message asking for address information. Alternatively, the user can set the device 200 in a state in which the device asks the user for confirmation to send a feedback message. Correspondingly, the feedback message coming to the mobile station is recognized as the contact information feedback message on the basis of an identifier in the message, after which the storage means in the mobile station 200, comprising a processor 201, a memory 202, at least one computer software application 203, are used to store the information contained by the feedback message, the contact information, in the memory 202 or register 208 of said device 200. The communication means are used to establish a connection between said device 200 and a communication network, the communication network being a mobile station network or the Internet, for example. The connection is established with another user of a mobile station. During said connection, a request message is sent to the mobile station of the other user and/or to a server in the network offering contact information services, the request message including an identifier, by means of which the receiver recognizes the message as a request message, and a request to send a feedback message as a response to said request message, the feedback message comprising further contact information related to said first piece of contact information. If said second mobile station or said server has a register or list of contact information comprising both said first piece of contact information and at least one second piece of contact information, which is attached to said first piece of contact information, both the first and the at least one second piece of contact information are sent in a feedback message to the device 200. Said second mobile station and said server contain means for recognizing the request message and for retrieving said at least one second piece of contact information from the memory of the device or server and generating means for generating the feedback message. The feedback message is received in the device 200 wirelessly and stored in the memory 202 or register 208 of the device. Finally, said first and said at least one second piece of contact information are linked in the memory 202 or register 208 to refer to each other.

FIG. 3a shows a system according to an embodiment of the invention, comprising a first mobile station 310, a second mobile station 320, a communication network 330 and a server 340, such as an address information server. The mobile station 310 is capable of communicating via the communication network 330 with the mobile station 320 and the server 340. The user of the mobile station 310 inputs (reference 301) to the mobile station 310 the first piece of contact information, which can be, for example, a telephone number or other piece of contact information, such as an e-mail address or a web page address. If the piece of contact information is a telephone number, as in the case, for example, that the user of the mobile station 310 calls the user of the mobile station 320 for the first time, the mobile station 310 establishes a connection (ref. 302) to the mobile station 320 via the communication network 330. In the next step, the mobile station 310 sends a request message (ref. 303) to the server 340, asking the server to deliver information to the mobile station 310, such as contact information related to the first piece of contact information. After this, the server 340 sends a feedback message (ref. 304) back to the mobile station 310; the feedback message can comprise at least one second piece of contact information related to said first piece of contact information, or alternatively the server 340 can report that the information requested is not found in the server. If the mobile station 310 receives at least one second piece of contact information, it stores (ref. 305) said piece of contact information in the memory 311 and links said piece of contact information to said first piece of contact information.

An alternative embodiment for receiving contact information for more than one mobile station simultaneously is described in the following. This implementation uses the point-to-multipoint or broadcasting method, in which a plurality of mobile stations receive the transmission simultaneously. This can, among other things, save the resources of the communication network, such as the mobile network.

The mobile station 310 calls/establishes a connection to a number/web address, or mobile station 320 in this example. Then the server in the network receives the identifier of mobile station 310, such as a subscriber identifier, and stores it in the memory of the server. The server also includes a counter 350, e.g. as computer software stored in the memory, which counts the number of request messages related to a certain object, such as a person or a company the contact information of which is wanted (for example, the number of mobile stations that have called the telephone number of a person or a company). This means that if said object has both a web address and a telephone number, for example, the counter calculates both the calls and visits to the web address. In this example, the value of the counter 350 is incremented by one as a response to a connection established to the mobile station 320. When the counter that refers to the identifier of mobile station 320 exceeds a certain threshold value, the server 340 transmits a feedback message comprising other contact information of the number/address (ref. 351) to the broadcast center 352, which cyclically transmits a feedback message (ref. 353) in its area as a broadcast transmission to a plurality of mobile stations simultaneously. The transmission can be implemented according to the DVB (Digital Video Broadcast) protocol, for example, as a unidirectional transmission through a separate broadcast network 360, for example. When the customer terminal, such as the DVB receiver of the mobile station 310, is on, it can receive the transmission and the feedback message.

Broadcasting is suitable for such places, for example, where connections to a certain number/address are established frequently. In order to make reception more effective, DVB transmissions must be performed cyclically for a certain time to ensure that as many receivers wanting information as possible are on at the moment of transmission.

To make sure that only the receivers who want a certain feedback message can receive said feedback message, computer software is stored in the terminal for storing the piece of contact information in the memory of the device when, for example, a communication connection is established on the basis of said piece of contact information and the request message is transmitted. The piece of contact information is stored in the memory of the DVB receiver in connection with the transmission of the request message, for example. Said piece of contact information operates as an identifier at the moment that the mobile station receives the broadcast feedback message. The DVB transmission contains an identifier/header at the beginning, indicating that the DVB transmission concerns e.g. the telephone number 09 1234567, or a request message for said piece of contact information. When the receiver (mobile station 310) recognizes the piece of information the same as the piece of contact information stored earlier (call number 09 1234567), the terminal 310 receives the data related to the identifier, i.e. further contact information related to telephone number 09 1234567 in this example, and stores it in the memory. A terminal which does not have said identifier stored in the memory does not receive said feedback message either.

FIG. 3b shows a system according to an alternative embodiment of the invention, comprising a first mobile station 310, a second mobile station 320 and a communication network 330. The mobile station 310 can communicate via the communication network 330 with the mobile station 320. The user of the mobile station 310 inputs (reference 341) to the mobile station 310 the first piece of contact information, which can be, for example, a telephone number or address information, such as an e-mail address or a web page address. If the piece of contact information is a telephone number, as in the case, for example, that the user of the mobile station 310 calls the user of the mobile station 320 for the first time, the mobile station 310 establishes a communication connection (ref. 342) to the mobile station 320 via the communication network 330. The mobile station 320 sends a feedback message 343 to the mobile station 310, the feedback message comprising the contact information stored in the mobile station, such as the telephone number, name or address information. The mobile station 310 receives said message 343 and stores it automatically in the memory 311.

FIG. 4 illustrates in an exemplary manner a list of contact information 400 according to an embodiment of the invention. Said list comprises information fields 401, such as name fields (references 404-407), e.g. company name information 406, personal name information in the form of surname and first name (references 404, 405), job title information 407 and numeric fields (references 408-411), such as telephone 408, mobile station 409, 410 or fax number information 411. In addition, the list of contact information 400 can comprise fields related to an information network, such as an e-mail address 412 or Internet address field 413 and mail and street address fields (references 414-417). Reference 402 is an example of a list of contact information for a private person, and reference 403 is an example of a list of contact information for a company.

FIG. 5a is an example of the structure of a request message. The request message 510 comprises a first identifier field SMS start 511, which indicates that the message starts from that record, and a second identifier field 512, on the basis of which the request message can be identified by the receiver of the message. The request message can also comprise a field 513 containing the first piece of contact information, which is advantageously the telephone number on the basis of which the communication connection between two mobile stations has been established, as in the descriptions of FIGS. 3a and 3b. The request message can also comprise a record field 514, in which it is indicated, for example, that the second piece of contact information related to said first piece of contact information, in field 513, should be sent as a feedback message to the sender of the request message, i.e. to the telephone number from which the request message has been sent. The record field 514 can comprise a request for sending only certain other contact information, such as all other telephone numbers, or alternatively for sending all possible contact information. The contents of the record field can be defined by the sender of the request message, for example. The fields 512-514 mentioned above correspond to the SMS message information of 160 characters. Finally, the request message comprises the record field SMS end 515, which indicates that the message ends at the record in question.

FIG. 5b is an example of the structure of the feedback message. The feedback message 520 comprises a first identifier field SMS start 521, which indicates that the message starts from that record, and a second identifier field 522, on the basis of which the feedback message can be recognized by the receiver of the message. The feedback message can also comprise fields 524, 528, 532 containing contact information, such as name, number or address information, and identifier fields 523, 527, 529 associated with said fields, on the basis of which the contents of the fields containing contact information can be stored in the right place at the reception end. Because the maximum length of the SMS message has been specified as 160 characters, the feedback message comprises identifiers (references 525, 526, 530 and 531), by which the receiver is informed that the message is longer than 160 characters. The number of contact information fields in the feedback message depends on the number of fields indicated in the request message and the total number of contact information items available. Finally, the feedback message comprises the record field 533, which indicates that the message ends at the record in question.

There are alternative implementations for the structure of the feedback message. In the first alternative, the feedback message comprises the identifier fields of all possible contact information fields regardless of whether the contact information field itself contains information or not. In that case, the request message and the feedback message have a standard form, and the request message can be made relatively short, because it does not specify in more detail which information the feedback message should contain. The contents of the feedback message are stored in the mobile station by examining whether the contact information field corresponding to the identifier field contains information or not.

In another alternative, the feedback message comprises only the contact information fields and corresponding identifier fields that have been mentioned in the request message. An advantageous feature in this case is the fact that the size of the feedback message does not grow large because of empty identifier fields of the contact data fields.

The implementation and embodiments of the invention have been presented here by means of examples. It is obvious to a person skilled in the art that the invention is not limited to the details of the embodiments described above, and that the invention can also be implemented in some other form without departing from the characteristic features of the invention. The embodiments presented should be regarded as illustrative but not restrictive. Thus the possibilities for the implementation and use of the invention are limited only by the accompanying claims. Therefore, the various alternative embodiments of the invention, including equivalent embodiments, fall within the scope of the invention.

1. A method for storing contact information in the memory of a first electronic device (310), which is capable of communicating via a communication network (330) with at least a second electronic device (320, 340); the method comprises steps in which:
a first piece of contact information is input to the first electronic device (310) for establishing a communication connection with said at least one second electronic device (320),
a communication connection is established via said communication network (330) between said first electronic device (310) and said at least one second electronic device (320) on the basis of said first piece of contact information, characterized in that the method also comprises:
sending a request message by said first electronic device (310) to said at least one second electronic device (320, 340) on the basis of said communication connection, the request message comprising a request for sending at least one second contact information update related to the first piece of contact information to said first electronic device (310),
sending a feedback message by said at least one second electronic device (320, 340) as a response to said request message, the feedback message comprising at least one second piece of contact information related to the first piece of contact information;
storing said first piece of contact information and said at least one second piece of contact information in the memory of said first electronic device (310).

2. A method according to claim 1, characterized in that said first electronic device is a mobile station operating in a wireless communication network.

3. A method according to claim 1, characterized in that said second electronic device is at least one of the following: a mobile station operating in a wireless communication network, a server operating in a wireless communication network.

4. A method according to claim 1, characterized in that said first piece of contact information and said second piece of contact information is at least one of the following: telephone number, e-mail address and web address.

5. A method according to claim 4, characterized in that said second piece of contact information is at least one of the following: name information, address information.

6. A method according to claim 1, characterized in that said request message is transmitted by the electronic device automatically when said communication connection is established for the first time.

7. A method according to claim 1, characterized in that the method also comprises linking said first piece of contact information and said at least one second piece of contact information to each other in the memory of the first electronic device.

8. A method according to claim 1, characterized in that said transmission of the request message takes place over a wireless communication network.

9. A method according to claim 1, characterized in that said feedback message is transmitted cyclically as a broadcast transmission along a different communication network to all the mobile stations that transmitted said request message.

10. A method according to claim 9, characterized in that said feedback message is transmitted when a certain threshold value specified for a broadcast transmission is reached.

11. A method according to claim 9, characterized in that said communication network is a DVB network.

12. A method according to claim 9, characterized in that said broadcast transmission is a DVB transmission.

13. An electronic device (200) for storing contact information in the memory of said device (202, 208), the device being capable of communicating via a communication network with at least one second electronic device; the device (200) comprising:
input means (204) for inputting the first piece of contact information to said electronic device (200) for establishing a communication connection with said at least one second electronic device,
communication means for establishing a communication connection via said communication network between said electronic device (200) and said at least one second electronic device on the basis of said first piece of contact information, characterized in that said device (200) also comprises:
request message generating means (201-203), the request message comprising a request for getting at least one second piece of contact information related to said first piece of contact information to said electronic device,
request message transmission means (201-207) for transmitting a request message by said electronic device to said at least one second electronic device on the basis of the communication connection established,
reception means (201-207) for receiving a feedback message, which comprises at least one second piece of contact information, as a response to the request message transmitted, the second piece of contact information relating to said first piece of contact information, and
storage means (201-203, 208) for storing said first piece of contact information and said second piece of contact information in the memory (202, 208) of said device.

14. A device (200) according to claim 11, characterized in that the device also comprises linking means (201-203, 208) for linking said first piece of contact information and said at least one second piece of contact information to each other in the memory of said electronic device.

15. A device (200) according to claim 11, characterized in that said request message transmission means (201-207) are arranged to transmit said request message automatically when said communication connection is established for the first time.

16. A device (200) according to claim 11, characterized in that said request message transmission means are arranged to transmit said request message over a wireless connection.

17. A device (200) according to claim 11, characterized in that said request message transmission means are arranged to transmit said request message in at least one of the following manners: SMS message and MMS message.

18. A device (200) according to claim 11, characterized in that the device also comprises feedback message generating means for generating a feedback message as a response to the request message received.

19. A device (200) according to claim 11, characterized in that said device is a mobile station operating in a wireless communication network.

20. A device (200) according to claim 11, characterized in that said feedback message reception means are arranged to receive a feedback message from a broadcast message transmitted in a different communication network.

21. An electronic device (200) for storing contact information in the memory of said device (202, 208), the device being able to communicate via a communication network with at least one second electronic device; the device (200) comprising:
a user interface (204, 205) for inputting a first piece of contact information to said electronic device (200) for establishing a communication connection with said at least one second electronic device,
a transceiver for establishing a communication connection via said communication network between said electronic device (200) and said at least one second electronic device on the basis of said first piece of contact information, characterized in that said device (200) also comprises:
a processor (201) configured to generate a request message, the request message comprising a request for getting at least one second piece of contact information related to said first piece of contact information to said electronic device,
the transceiver (206-207) being configured to transmit a request message by said electronic device to said at least one second electronic device on the basis of the communication connection established,
the transceiver (206-207) being configured to receive a feedback message, which comprises at least one second piece of contact information, as a response to the request message transmitted, the second piece of contact information relating to said first piece of contact information, and the device comprises
a memory (202) for storing said first piece of contact information and said second piece of contact information.

22. A system for storing contact information in the memory (311) of the first electronic device (310), the system comprising:
a first electronic device (310) and at least one second electronic device (320, 340), the first electronic device (310) being capable of communicating via a communication network (330) with said at least one second electronic device (320, 340),
input means (204, 205) for inputting the first piece of contact information to the first electronic device for establishing a communication connection with said at least one second electronic device,
communication means (201, 206, 207, 203) for establishing a communication connection via said communication network (330) between said first electronic device (310) and said at least one second electronic device (320, 340) on the basis of said first piece of contact information, characterized in that the system comprises:
request message transmission means (201, 203, 206, 207) for transmitting a request message by said first electronic device (310) to said at least one second electronic device (320, 340) on the basis of the communication connection established, the request message comprising a request for sending at least one second piece of contact information related to the first piece of contact information to said first electronic device (310),
feedback message transmission means (201, 203, 206, 207) for transmitting a feedback message from said at least one second electronic device (320, 340) as a response to the request message received, the feedback message comprising at least one second piece of contact information related to said first piece of contact information, and
storage means (201, 202, 203, 208) for storing said first piece of contact information and said second piece of contact information in the memory (311) of said first electronic device (310).

23. A computer software product (203) for an electronic device (310, 320) for storing contact information in said electronic device (310, 320), the electronic device (310, 320) being capable of establishing a communication connection via a communication network (330) with at least one second electronic device (310, 320, 340) on the basis of a first piece of contact information formed in said first electronic device (310, 320), characterized in that the computer software product comprises:
computer software means (203) for generating a request message, the request message comprising a request for sending at least one second piece of contact information related to said first piece of contact information to said device,
computer software means (203) for causing said first electronic device (310, 320) to send said request message to at least one second electronic device (310, 320, 340) on the basis of said communication connection established,
computer software means (203) for causing said electronic device to receive a feedback message, which comprises at least one second piece of contact information, as a response to the request message transmitted, the second piece of contact information relating to said first piece of contact information,
computer software means (203) for storing said first piece of contact information and said at least one second piece of contact information in the memory of said electronic device (310, 320).
